(19) United States
(12) Patent Application Publication
(10) Pub. No.: US 2014/0026086 A1
(43) Pub. Date: Jan. 23, 2014

(54) Methods and Systems for Cross-Platform Computing Applications Featuring Adaptable User Interfaces

(71) Applicants: Dave Zuverink, San Jose, CA (US); Chiedozi Acholonu, San Francisco, CA (US); Eliot Greenfield, Oakland, CA (US); Glenn Ruehle, Novato, CA (US); Carol Lindburn, San Francisco, CA (US); Greg Burch, Walnut Creek, CA (US)

(72) Inventors: Dave Zuverink, San Jose, CA (US); Chiedozi Acholonu, San Francisco, CA (US); Eliot Greenfield, Oakland, CA (US); Glenn Ruehle, Novato, CA (US); Carol Lindburn, San Francisco, CA (US); Greg Burch, Walnut Creek, CA (US)

(73) Assignee: Adobe Systems Incorporated, San Jose, CA (US)

(21) Appl. No.: 12/769,154

(22) Filed: Apr. 28, 2010

(51) Int. Cl. G06F 3/048

(52) U.S. Cl. 715/765

(57) ABSTRACT

Methods, systems, and computer-program products are disclosed. A cross-platform application can access a platform identifier indicating a characteristic of a computing system in response to beginning execution of the application. User interfaces can be provided interface based at least in part on the platform identifier and an interaction model, with the interaction model used to define the layout and content of the interface. The model can be separate from the program component that provides the user interface, and so the application can customize at least some aspects of its output for different platforms based on the platform identifier. Embodiments also include the use of screen-based application navigation.

### TECHNICAL FIELD

The disclosure below generally relates to development and configuration of computer applications, including development and architecture of cross-platform computer applications.

### BACKGROUND

Modern software developers are faced with a large number of platforms to target. For example, mobile devices continue to proliferate in popularity and each mobile device platform may provide an operating environment (e.g., hardware and/or software context) to take into account in developing applications. Cross-platform runtime environments (e.g., Adobe® Flash® or Air®, available from Adobe Systems Incorporated of San Jose Calif.) may be of some assistance, but additional issues may remain in cross-platform development. One potential issue in cross-platform development is that for an application to be successful, the application should comply with user interface and other guidelines for each platform. In some cases, applications that do not comply with such guidelines will not be distributed at all.

### SUMMARY

Although a developer may code a single version of an application that would execute across multiple platforms, the lack of customization can result in a compromised user experience. On the other hand, customizing a version of the application for each platform may be time-consuming and expensive.

Embodiments configured in accordance with aspects of the present subject matter can alleviate at least some of these difficulties in cross-platform application development by providing methods and systems for developing and executing applications that place a layer of abstraction referred to as an “interaction framework” between the application logic and the user interface for at least some of the user interface components.

Embodiments include a computer-implemented method that comprises accessing a platform identifier indicating a characteristic of a computing system in response to beginning execution of the application. The method can further comprise providing a user interface based at least in part on the platform identifier and an interaction model, with the interaction model used to define how at least some aspects of the user interface are provided. The interaction model can be a separate program component of the application from the program component(s) providing the user interface, and so the application can customize its output based on the platform identifier.

For example, the application can include one or more application logic modules defining at least one function that accesses an input value and generates an output value based on the input value, with the values corresponding to user interface objects. Providing the user interface can comprise constructing a user interface by instantiating a plurality of interface elements based on interface objects identified in the interaction model for use with the particular computing system. The interface elements can comprise, for example, a title bar, a tab bar, a soft key bar, and/or a navigation button, and the interaction model may further include a skin or other data indicating how the elements are to be laid out in a screen.

The interaction framework can also be used to handle other input values, such as device-specific events, as well as output that is not displayed. Additionally, in some embodiments the application logic defines at least some aspects of the interface (e.g., content panes providing application output, toolbar containers) directly while relying on the interaction framework to handle other aspects, such as navigation buttons, menu/command buttons, titles, application “chrome,” and the like.

These illustrative embodiments are discussed not to limit the present subject matter, but to provide a brief introduction. Additional embodiments include computer-readable media and computer systems embodying a cross-platform application configured in accordance with aspects of the present subject matter, and also embodiments of configuring a compiler to provide cross-platform applications and/or applications that otherwise use a screen-based navigation flow. These and other embodiments are described below in the Detailed Description. Objects and advantages of the present subject matter can be determined upon review of the specification and/or practice of an embodiment in accordance with one or more aspects taught herein.

### BRIEF DESCRIPTION OF THE DRAWINGS

A full and enabling disclosure is set forth more particularly in the remainder of the specification. The specification makes reference to the following appended figures.

FIG. 1 is a diagram illustrating exemplary computing device platforms along with examples of differences in interfaces that can be addressed using embodiments of the present subject matter.

FIG. 2 is a diagram showing illustrative program components of a cross-platform application.

FIG. 3 is a diagram showing an illustrative computing system configured by a cross-platform application to provide input and to provide output.

FIG. 4 is a flowchart showing steps in an illustrative processing method carried out by embodiments of a cross-platform application.

FIG. 5 is a flow diagram showing an example of creating a cross-platform application in accordance with aspects of the present subject matter.

FIG. 6 is a flowchart showing steps in an illustrative processing method carried out by embodiments of a computing application that utilize a screen-based application flow.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

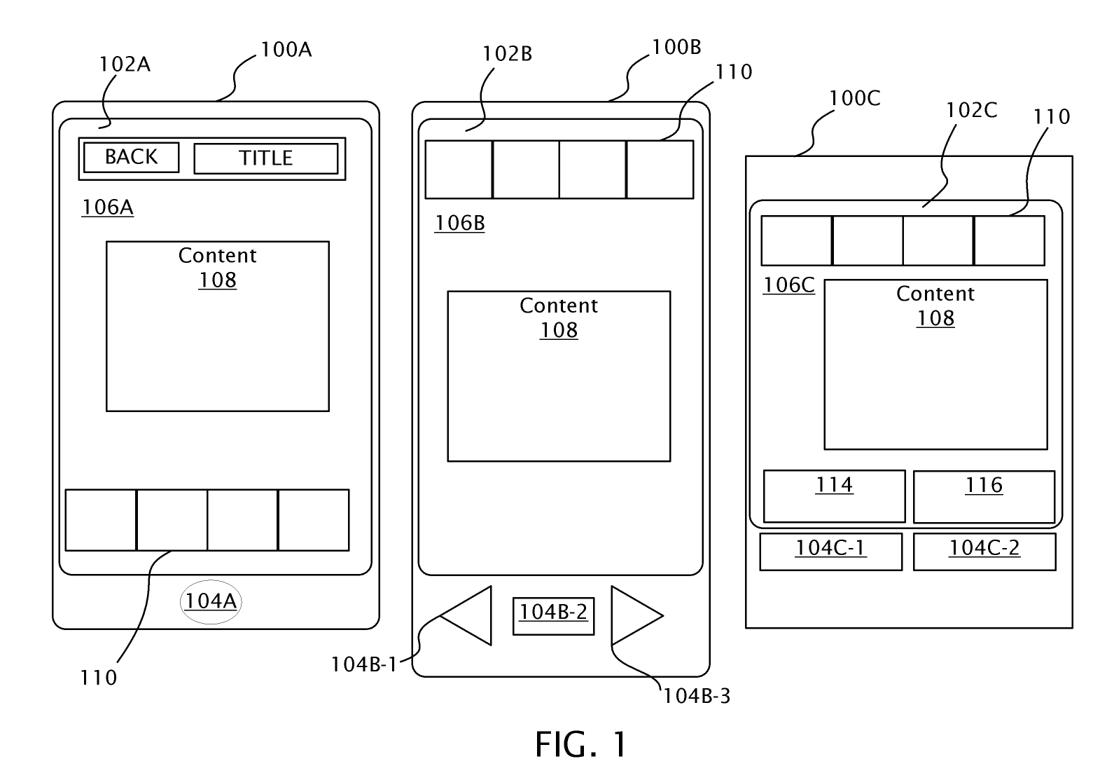

FIG. 1 is a diagram illustrating exemplary computing device platforms 100A, 100B, and 100C along with examples of differences in interfaces that can be addressed using embodiments of the present subject matter. Particularly, each computing device platform includes a respective display 102A, 102B, 102C but the different platforms include different types of input options. For instance, platform 100A includes a single hardware button or key 104A. As an example, key 104A may comprise a “home” key reserved for use by the operating system of platform 100A. On the other hand, platform 100B includes three keys 104B-1, 104B-2, and 104B-3. These keys may be accessible by applications running on platform 100B, or may be reserved for certain functionality, such as “back,” “menu,” and “forward,” respectively. Platform 100C includes two keys 104C-1 and 104C-2. For instance, keys 104C may be “soft keys” that can be mapped to application functionality.

Each platform is configured by a respective instance of a cross-platform application to provide a user interface 106 (illustrated as 106A, 106B, and 106C for the respective platforms) displaying content 108. Content 108 may comprise any suitable output generated by an application including, but not limited to textual, visual, or other content, such as email, web content, maps, communications content (e.g., video and/or audio), and the like. Generally speaking, content 108 is generated by application logic using one or more functions that generate output values based on input values. Content 108 may include output and/or input—for example, content 108 may include text and image fields of a planner or address book, along with an input field for searching the address book. Of course, the exact nature of content 108 will vary according to the purpose and state of the application.

As mentioned previously, one issue that may be encountered in cross-platform application development is that different platforms may have a variety of interface options and capabilities. Thus, even if a developer could potentially code an application once and compile the application into different executables for different platforms, or compile the application once into bytecode for use in a cross-platform runtime container on each platform, the lack of interface customization can be problematic in that on at least one of the platforms (and likely all of the platforms), the user will face a sub-optimal experience. Still further, some or all of platforms 100A, 100B, and/or 100C may restrict distribution of applications to those applications that meet certain guidelines (e.g., human interface guidelines (HIGs)).

As a particular example, on platform 100A, the tab bar 110, which may comprise application controls (e.g., web browser tabs, different application views, etc.) is displayed at the bottom of interface 106A, while for platforms 100B and 100C, the tab bar 110 is presented at the top of the screen. The particular placement of tab bar 110 for platform 100A may be required to accommodate other platform requirements, such as a requirement that the navigation bar 112 of platform 100A be displayed at the top along with a back button, since platform 100A lacks a hardware “back” button.

On the other hand, the user interface 106B of platform 100B need not include a “back” button in the displayed portion of the interface. Instead, one or more interface objects can be instantiated to utilize hardware buttons 104B for navigation functions. For example, a requirement or best practice for developers on platform 100B may be for “back,” “forward,” and “menu” functions to be mapped to respective keys 104B.

Platform 100C presents still further variations. Soft keys 104C may be freely available for any desired use by developers. Thus, interface objects are instantiated so that elements 114 and 116 are displayed in interface 100C to map functions (e.g., forward, back) to keys 104C-1 and 104C-2, respectively. Additionally, tab bar 110 should be positioned so as not to confuse users and so the recommendations or requirements of platform 110 may call for tab bar 110 to be at the top of the interface.

Ultimately, the developer of the cross-platform application will code application logic to respond to input commands (e.g., back, forward, and menu) and/or events with appropriate output. However, an appreciable amount of effort may be needed to customize the user interface of the application to leverage the particular capabilities and/or meet the requirements of platforms 100A, 100B, and 100C. The developer's task may be eased by embodiments of the present subject matter—a framework can be used so that the user interface of the application customizes itself based on an interaction model associated with the respective platforms.

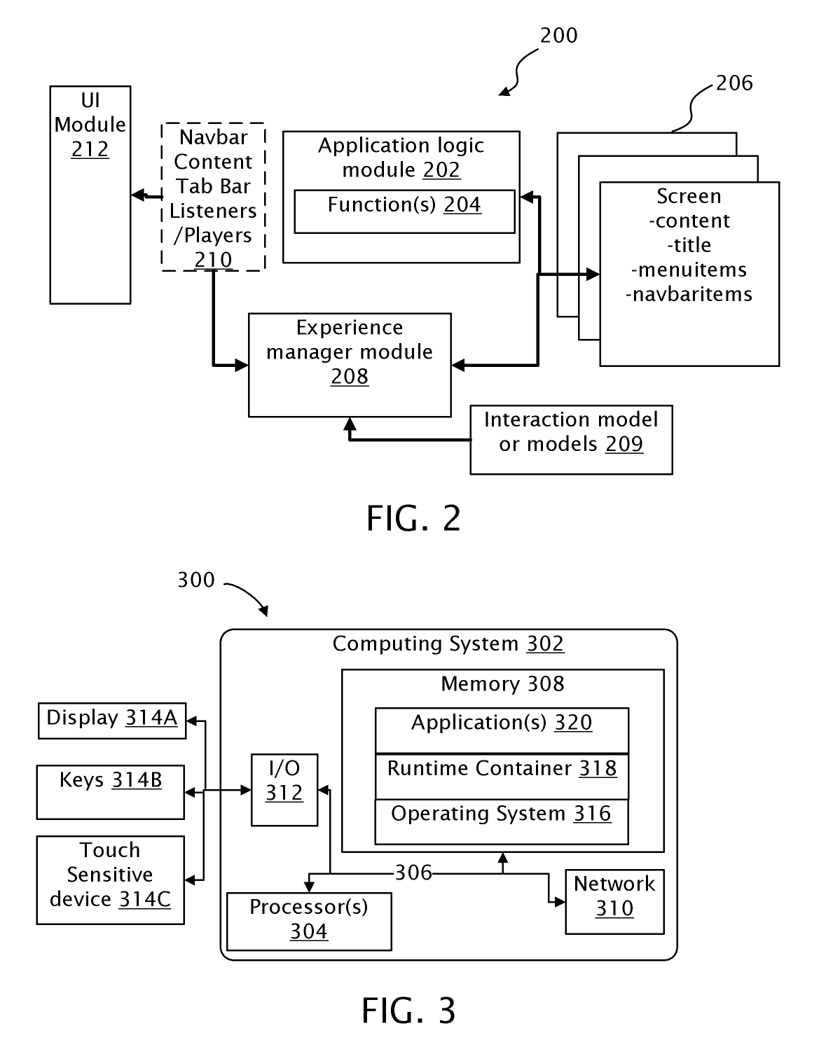

FIG. 2 is a diagram showing illustrative program components of a cross-platform application 200. For example, the program components may be embodied in a computer program product comprising a non-transitory computer-readable medium (e.g., a memory or other storage device) accessible by a computing system. In this example application 200 comprises an application logic module 202 which, generally speaking, comprises code 204 that configures the computing system to carry out at least one function to generate an output value based on an input value.

The particular functionality provided by an application can, of course, vary and the present subject matter is not intended to be limited to particular goals or substantive capabilities of the application. For instance, the application could comprise a simple text viewing application that accesses a stream of textual data (e.g., representing an electronic message) and displays the text onscreen by populating an interface object such as a textbox. Other examples include communications applications (e.g., telephone, videoconferencing, etc.), an image editor, a web browser, a mapping application, or any other type of application.

In this example, the application logic module 202 uses function(s) 204 to generate a plurality of screens 206. As noted later below, screens 206 can each comprise a plurality of interface objects associated with a particular state of application 200 and a data model for rendering an interface view. The interface objects may map to interface elements used in rendering the view, but may also include other objects that are not displayed but are used to handle other aspects of the user interface, such as objects that handle hardware input/output events (e.g., hardware key presses, device events, etc.) and/or other events, such as data and events from remote sources, and objects such as navigation bars, toolbars, etc. that act as containers for other objects such as navigation buttons, toolbar commands, etc.

As shown here, the screens include interface objects such as the content object(s), a value for the title, lists of menu bar items, and navigation bar items. However, the depiction of screens 206 in this example is not intended to be limiting. Rather, in some embodiments application logic module 202 may generate objects or other program components for use in providing user interfaces without the need to organize the objects into screens based on application state.

Application 200 also comprises an experience manager module 208 comprising code that configures the computing system to access an interaction model based on the identity or other characteristic of the computing system and to adapt how user interface module 212 configures the computing system to provide the user interface. By coding application 200 to utilize experience manager module 208, the application logic can be separated from the particular manner in which at least some aspects of the user interface are rendered.

User interface module 212 comprises code that configures the computing system to provide a user interface based on a plurality of user interface objects and a data model. For instance, user interface module 212 may render interface elements onscreen based on output values associated with user interface objects, and can pass input values using other user interface objects. Instead of the application logic directly specifying all of the user interface elements, which would require specific coding of the application logic for different platforms, the application logic module 202 interfaces with experience manager module 208, which uses an interaction model 209 to configure (as represented at 210) user interface module 212 to generate specific user interface behavior for the platform.

Interaction model 209 can comprise parameters controlling which user interface elements are to be rendered, the layout of the elements, and other information for use by user interface module 212 in providing the user interface based on user interface objects. Particular elements available for generating the user interface may be specified on a platform-by-platform basis, such as using XML or other markup such as MXML. For example, the interaction model may define skins for the application using cascading stylesheets (CSS) or use another type of markup to indicate layout, color, fonts, etc.

As a particular example, a screen 206 may include a content object, a title object, menu objects, and navbar objects, such as a “back” object that relays a “back” event to the application logic. Experience manager module 208 can select an appropriate interaction model 209 from a plurality of available models based on an identifier or other characteristic of the platform. For instance, module 208 may determine that when the application is executed on platform 100A that a back button is to be included in navigation bar 112 and associated with the “back” object. Experience manager module 208 can construct an appropriate user interface by directing user interface module 212 to render corresponding elements in the user interface, such as by instantiating a visual element for the onscreen back button, placing it in the navigation bar or another container, associating it with the application logic, and placing the button on a display list for rendering by UI module 212. The experience manager module 208 may also determine a position for the button (and its container) based on layout information in the interaction model.

On the other hand, management module 208 may select a different interaction model 209 when the application is executed on platform 100B to direct user interface module 212 to render a different interface. Instead of instantiating and positioning a display element, module 208 can map key 104B-1 to an object that dispatches a “back” event to the application logic.

The “back” button example is for purposes of example only. Other examples of user interface components can include navigation bars used to expose information and controls related to the current view, the toolbar that display information (e.g., title) and allows a user to provide actions with respect to a current screen, the tab bar, the soft key bar (i.e., the container for soft keys), and an option menu. The application content is handled directly in this example—that is, for each screen, the screen content is defined by the application logic module 202 and is then rendered by the UI module 212 without changes by the experience manager module. However, a developer could add new abstractions beyond those provided in the present examples.

Application logic module 202 may also rely on a device identifier in determining which objects are to be used. In the example above, a navigation bar container was instantiated by the application logic module 202. This may occur, for example, in response to application logic that determines that the device or platform requires a navigation bar. On the other hand, the application logic may specify that no navigation bar container is needed on a different platform (e.g., a platform with dedicated navigation buttons).

FIG. 3 is a diagram showing an illustrative computing system 300 configured by a cross-platform application to provide input and to provide output. In this example, system 300 includes a computing device 302 that comprises one or more processors 304, a tangible, non-transitory computer-readable medium (memory 308), a networking component 310, and several I/O components 314 linked to processor 304 via I/O interface(s) 312 and bus 306. For example, system 300 may comprise a mobile device, such as a tablet computer, a mobile phone, an e-book reader, or another computing system (e.g., desktop, laptop, kiosk, etc.).

For example, memory 308 may comprise RAM, ROM, or other memory accessible by processor 304. I/O interface 312 can comprise a graphics interface (e.g., VGA, HDMI) to which display 314A is connected, along with a USB or other interface to which one or more keys 314B and a touch-sensitive device 314C are connected. Display 314A can use any technology, including, but not limited to, LCD, LED, CRT, and the like. Networking component 310 may comprise an interface for communicating via wired or wireless communication, such as via Ethernet, IEEE 802.11 (Wi-Fi), 802.16 (Wi-Max), Bluetooth, infrared, etc. As another example, networking component 310 may allow for communication over communication networks, such as CDMA, GSM, UMTS, or other cellular communication networks.

Embodiments of the present subject matter can use any suitable technology or combination of technologies to determine the location and nature of touch inputs and to recognize touch gestures from those inputs, such as one or more optical, capacitive, resistive, and/or other sensors that provide data that computing device 302 can use to determine the location of touches in the touch area. It will be understood that platform capabilities can vary. For instance, some platforms may have more or fewer keys (or no keys at all). Additionally, a platform may have different touch recognition capabilities—for example, one platform may recognize multitouch while another may not—and some platforms may lack touch recognition capabilities entirely.

Operation of computing device 302 is configured by program components embodied in the memory 308. In this example, an operating system 316 provides an environment in which one or more applications, including a runtime container 318, are executed. For example, runtime container 318 may comprise an instance of the Adobe® Air® or Flash® runtime, available from Adobe Systems Incorporated of San Jose, Calif. Cross-platform application 320 may comprise code configured to execute within runtime container 318, and can include application logic, an experience manager, and other components as discussed herein. Additionally or alternatively, application 320 may use a screen-based navigation model as discussed further below.

Although a runtime container is shown in this example, other embodiments may provide a cross-platform application 320 including application logic and an experience manager (and/or a screen-based navigation flow) but configured to execute directly within the environment of operating system 316. As an example, code for a runtime application could be packaged (e.g., with a compatibility layer) for execution as native machine code or the code for the application could be compiled directly into native machine code. Still further, runtime container 318 or even operating system 316 could be modified to include an experience manager to be invoked by elements of applications executed therein.

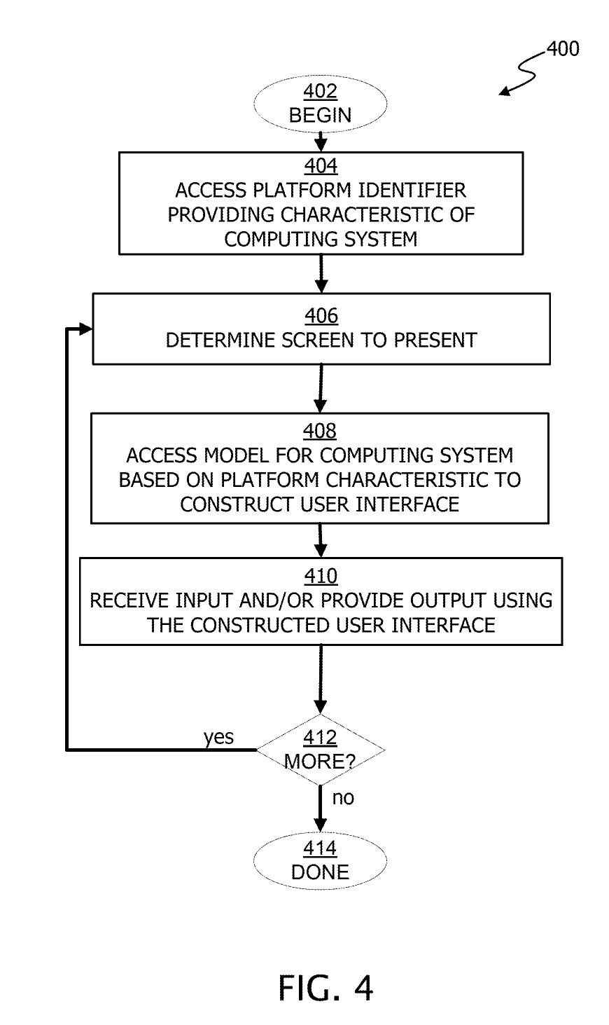

FIG. 4 is a flowchart showing steps in an illustrative processing method 400 carried out by embodiments of a cross-platform application. Block 402 represents beginning execution of the application by the computing system, such as reserving memory and other resources, initializing components of the application itself (e.g., object constructors, the experience manager, etc.), loading data, and otherwise bringing the application to an initial state. After beginning execution, as shown at block 404, the application accesses a platform identifier indicating a characteristic of the computing system. As an example, the platform identifier may comprise an identifier of the hardware platform, operating system, runtime environment (if used), or any other identifier that can be used to assess the capabilities of the platform for use in selecting an interaction model.

Blocks 406-410 represent an example of providing a user interface based on the platform identifier and an interaction model, with the interaction model is used to define how the user interface is provided. The model can be used to define layout characteristics and content of the user interface. In this example, block 406 represents determining a screen to present, with the screen defined by one or more interface objects. However, the use of a “screen” in this example is not intended to be limiting. More generally, the application logic can determine one or more objects for use in desired input and output for the application, along with corresponding data values for the objects.

The interface objects may, for example, correspond to program components used to provide interface elements such as onscreen content (e.g., text boxes and other containers), controls, and/or containers (e.g., buttons, navigation bars/panels, title bars, input boxes, etc.). The interface objects may also comprise other program components used to handle input and/or output data provided using components other than the screen. For example, an interface object can be used to receive input data via keys, such as buttons 104 of FIG. 1, or to provide output via other components such as speakers, vibration actuators, and the like.

Block 408 represents using a model for the computing platform to construct a user interface that is then provided by the user interface module of the application, and can be carried out by an experience manager module. For example, as mentioned above an interaction model for a computing platform may indicate that a “back” hardware button is available. The experience manager module can instantiate an object that acts in response to the “back” hardware button to relay appropriate data to the application logic. Based on a skin or other set of layout information for the platform, the remainder of the interface can be rendered. On the other hand, if the interaction model indicates that an onscreen “back” button is to be provided, then the experience manager module can instantiate an object with a corresponding button element in the interface, with the skin indicating where the button element is to be placed (along with other features such as color, font, etc.). The experience manager may, for example, use a container instantiated by other application logic in response to the platform identifier, such as a navigation bar container. Alternatively, the experience manager could instantiate the container itself as well.

Block 410 represents receiving input and/or providing output by way of the user interface. For example, onscreen elements can be populated using data according to a data model specified by the application logic. User input events can be handled by appropriate objects (e.g., objects associated with hardware keys, the touch interface, etc.) and relayed to the application logic, along with other events such as data from remote sources.

As an example, an interface object may handle determining location data. If the interaction model for the platform indicates that GPS is available, the interface object can obtain data from the GPS components for the platform. On the other hand, if the interaction model indicates that there is no GPS, then the interface object may use another source of location data (e.g., an IP-based triangulation data service) or may not be used at all. Similarly, on onscreen location indicator may be rendered and populated if location data is available to the platform, but may otherwise not be provided.

Block 412 represents determining if execution is to continue. If so, then the method loops back to block 406 where another screen is determined. The screen may use the same objects but with different values, or the screen content may change based on application flow. If at block 412 execution is complete, then the method branches to block 414.

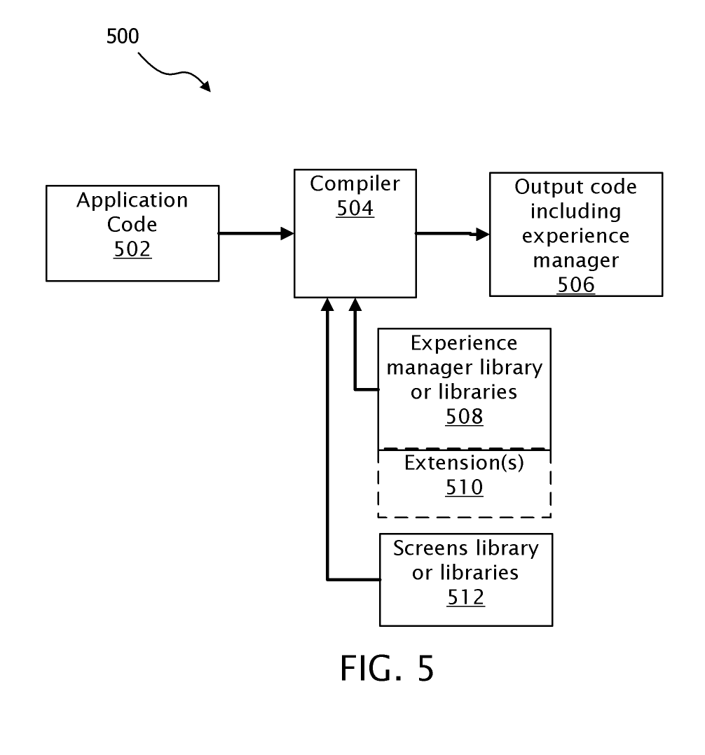

FIG. 5 is a flow diagram 500 showing an example of creating a cross-platform application in accordance with aspects of the present subject matter. In this example, code 502 represents source code for a cross-platform application, and can include routines defining the desired program flow and application logic. In some embodiments the present subject matter can be implemented by configuring compiler 504 to recognize calls to an application programming interface (API) to so that output code 506 includes code for providing an experience manager.

Output code 506 may comprise executable code or bytecode for execution in a runtime container. As an example, output code 506 may comprise a SWF file for use in the Flash® runtime environment, an AIR® file, or an application for execution within an operating system. Alternatively, output code 506 may represent an intermediate product that is then linked or further processed before being ready for execution/interpretation.

Compiler 504 may be a standalone application executed by a computing system or may be a feature of another application or suite, such as an interactive development environment (IDE). In any event compiler 504 can include an input/command module that recognizes input commands, a parser that accesses code 502, and construction logic that puts together output code 506 in accordance with the syntax of code 502. Compiler 504 can be configured to recognize the syntax of the experience manager API and to use one or more libraries 508 in order to generate code for the experience manager and to appropriately link the functional components of the application logic and the experience manager. The compilation process can also, of course, include generating program code to provide other components (e.g., object setup/teardown, a user interface module, etc.).

In some embodiments, libraries 508 include a base class for the experience manager and classes for various platforms, with the different classes defining the interaction models in terms of platform characteristics and interface skins The classes can also be extended as shown at 510 if a developer wishes to add support for a new platform. Code 502 could then simply be re-compiled so that the newly-produced output code 506 includes the capability to run on the new platform.

In various embodiments, output code 506 can include an not only code for an experience manager, but also a number of interaction models, one of which is selected when the code is executed/interpreted by a computing device based on a platform identifier. Thus, the same output code 506 could be executed on different platforms with different resulting interface behavior. However, in some embodiments compiler 504 allows a user to select one or more target platforms. In such cases, output code 506 can include the experience manager and only the one or more corresponding interaction models.

FIG. 5 also illustrates use of another set of libraries, namely screens library or libraries 512. As mentioned above, in some embodiments an application can be developed using a screen-based navigation model. Particularly, application code 502 can be written using syntax recognized by compiler 504 as invoking a screens API. The flow of the application can be configured to move between different screens associated with states of the application. Particularly, the application logic can be configured to include a navigation component to navigate between different screens, maintain a history of which screens have been navigated to. The screens can be pushed and popped from a stack, with the topmost screen in the stack being used to generate the user interface.

In some embodiments, a computing system is configured to provide cross-platform application development by loading one or more program components of a compiler in memory. As noted above, the compiler may be a standalone application or may be included in an IDE. The compiler can be configured to recognize a cross-platform development API by directing the compiler to access one or more libraries such as experience manager library/libraries 506, comprising code which, when compiled/interpreted, results in output code that is executable to provide the experience manager. As an example, a software development kit (SDK) including library/libraries 506 may be distributed to a developer who then directs the compiler to use the libraries in the SDK. The SDK may additionally or alternatively include screens libraries 512 as well, and can of course include other libraries, API documentation, and the like.

As noted above, the screen can be defined as a set of interface objects, along with a data model for use in populating the interface objects. The objects identified in the screen at the top of the stack can be instantiated and then populated with corresponding data. When the screen-based flow is used, the application logic can also include suitable routines to pass data between screens and to generate transition effects (e.g., pan, swipe, dissolve, etc.) between screens.

If the screen-based flow is used with an experience manager, the experience manager can instantiate the objects for providing the interface in accordance with the interaction model to provide the desired user interface behavior. As noted above, although the screen-based application flow may aid in implementing a computing application that uses an experience manager, the experience manager could be used even without a screen-based navigation flow. Still further, an application could use a screen-based navigation flow even without an experience manager.

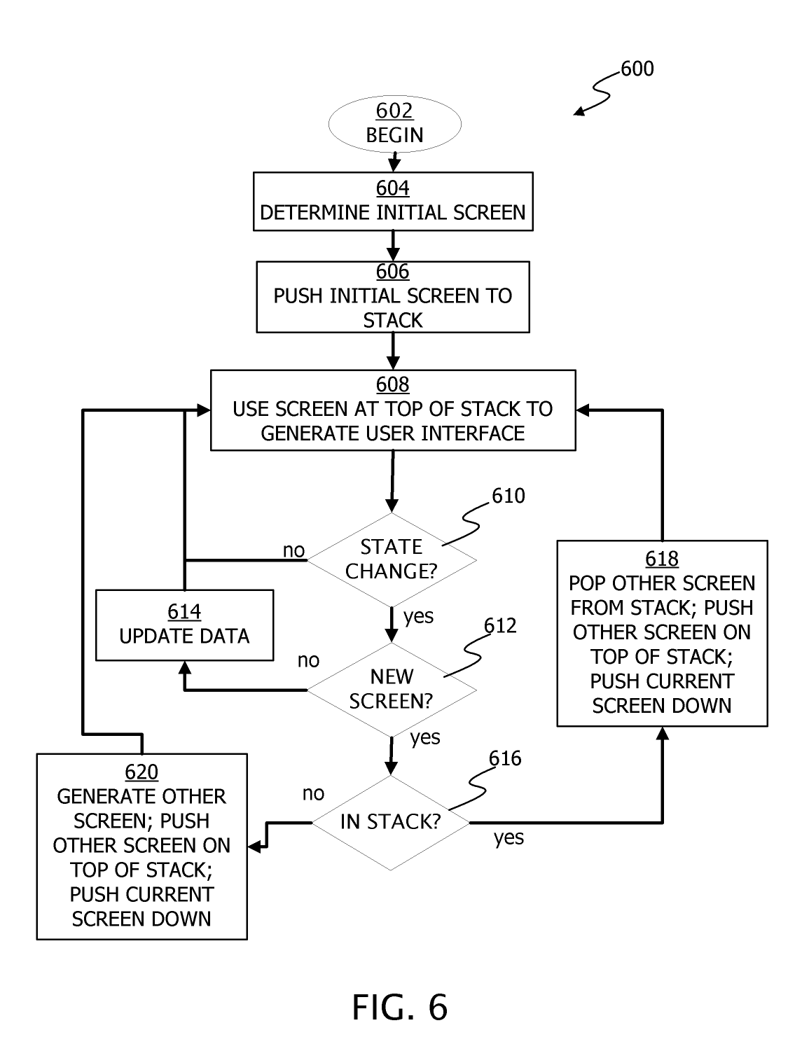

FIG. 6 is a flowchart showing steps in an illustrative processing method 600 carried out by embodiments of a computing application that utilize a screen-based navigation flow. Block 602 represents beginning execution of the application. Block 604 represents determining an initial screen for the application. This may, for example, comprise identifying a set of objects used in providing a title screen or initial view. Block 606 represents pushing the initial screen onto the screen stack.

Block 608 represents using the topmost screen of the stack to provide a user interface. For example, the objects of the screen can be instantiated to generate corresponding interface elements and/or other objects such as event watchers/handlers for use in interacting with hardware components, remote data resources, and the like. Block 610 represents determining if the application state has changed. For instance, user input may be provided via the interface and/or other data or events may be received and processed by the application logic to determine that the application state has changed. If no state change has occurred, the method loops back to block 608 until the state changes.

If the application state changes, then flow moves to block 612, which represents determining if the same screen is to be used for the new state. An application may not feature a one-to-one mapping of screens to states. Instead, the same screen could correspond to multiple states—e.g., the same screen could be used to present different data according to the different states. In that case, the resulting outcome is for the screen to remain at the top of the stack but to be populated with updated data as shown at block 614 and flow returns to block 608.

On the other hand, the new state could correspond to another screen. In that case, flow moves from block 612 to block 616, which represents determining if the other screen is already on the stack. This may be the case, for example, if a program has been executing for some time and the screen has already been reached previously. If the screen is on the stack, then flow moves from block 616 to block 618, which represents popping the other screen from the stack and pushing the other stack to the top of the stack, along with pushing the screen previously at the top of the stack further down in the stack. Flow then returns to block 608.

Embodiments can vary the amount of screen data that is pushed down the stack. For example, both the set of objects and the data model used to populate the screen may be pushed together. This can increase memory requirements of the stack but with the advantage that the screen can be regenerated more quickly. On the other hand, a stack may be pushed as only a set of objects; this approach may be more advantageous for screens whose data is likely to be repopulated when the screen is used for the user interface—if the data is to be repopulated anyway, there is little advantage in storing it. The options for storing the data can be set using respective commands by a developer invoking the screens API in source code.

Returning to block 616, the other screen may not be on the stack. In that case, flow moves to block 620, which represents generating the screen, followed by pushing the screen to the top of the stack at block 622 along with pushing the other stack contents downward. For example, the application logic may define each screen in terms of corresponding objects for the screen; when the screen is to be generated, the list of corresponding objects can be added to the stack. Flow then proceeds to block 608. Although not shown in FIG. 6, the method can of course include an exit routine.

### General Considerations

Some portions of the detailed description were presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here and generally is considered to be a self-consistent sequence of operations or similar processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels.

Unless specifically stated otherwise, as apparent from the foregoing discussion, it is appreciated that throughout this specification discussions utilizing terms such as “processing,” “computing,” “calculating,” “determining” or the like refer to actions or processes of a computing platform, such as one or more computers and/or a similar electronic computing device or devices, that manipulate or transform data represented as physical electronic or magnetic quantities within memories, registers, or other information storage devices, transmission devices, or display devices of the computing platform.

Although several examples featured mobile devices, the various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software, that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, cause the at least one computer to implement one or more embodiments of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Examples of computing devices include, but are not limited to, servers, personal computers, personal digital assistants (PDAs), cellular telephones, televisions, television set-top boxes, portable music players, and consumer electronic devices such as cameras, camcorders, and mobile devices. Computing devices may be integrated into other devices, e.g. “smart” appliances, automobiles, kiosks, and the like.

The inherent flexibility of computer-based systems allows for a great variety of possible configurations, combinations, and divisions of tasks and functionality between and among components. For instance, processes discussed herein may be implemented using a single computing device or multiple computing devices working in combination. Databases and applications may be implemented on a single system or distributed across multiple systems. Distributed components may operate sequentially or in parallel.

When data is obtained or accessed as between a first and second computer system or components thereof, the actual data may travel between the systems directly or indirectly. For example, if a first computer accesses data from a second computer, the access may involve one or more intermediary computers, proxies, and the like. The actual data may move between the first and second computers, or the first computer may provide a pointer or metafile that the second computer uses to access the actual data from a computer other than the first computer, for instance. Data may be “pulled” via a request, or “pushed” without a request in various embodiments.

Communications between systems and devices may occur over any suitable number or type of networks or links, including, but not limited to, a dial-in network, a local area network (LAN), wide area network (WAN), public switched telephone network (PSTN), the Internet, an intranet or any combination of hard-wired and/or wireless communication links.

Any suitable non-transitory computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computer-implemented method, comprising:
executing an application logic module by a computing system, wherein the application logic module includes at least one function that accesses an input value and generates an output value based on the input value;
accessing a platform identifier, the platform identifier indicating a characteristic of the computing system;
selecting, by an experience manager module executed by the computing system, an interaction model for the computing system based on determining that the interaction model is compliant with at least one guideline corresponding to the platform identifier, wherein the at least one guideline specifies at least one requirement for applications executed on computing systems having the characteristic of the computing system;
determining, by the experience manager module, at least one input program component for obtaining the input value via an input device of the computing system and corresponding to an input object identified in the interaction model;
determining, by the experience manager module, at least one output program component for providing the output value via an output device of the computing system and corresponding to an output object identified in the interaction model; and
generating a graphical interface based on the interaction model,
by instantiating a plurality of interface objects, wherein the plurality of interface objects as instantiated comprises respective instances of the at least one input program component and the at least one output program component.

2. The method set forth in claim 1, wherein the interaction model comprises a first program component separate from a second program component comprising code for generating the graphical interface the graphical interface.

3. The method set forth in claim 2, wherein the plurality of interface objects comprises at least one of a title bar, a tab bar, a soft key bar, and a navigation button.

4. The method set forth in claim 3, wherein generating the graphical interface further comprises laying out the plurality of interface objects as instantiated in a screen based on a skin included in the interaction model.

5. The method set forth in claim 4, further comprising:
navigating between at least a first screen and a second screen;
maintaining a screen stack comprising a first plurality of interface objects, for the first screen and a second plurality of interface objects for the second screen; and
wherein providing the graphical interface comprises:
selecting at least one of the first plurality of interface objects or the second plurality of interface objects based on the at least one of the first plurality of interface objects or the second plurality of interface objects being at the top of the stack:
instantiating the plurality of interface objects based on the at least one of the first plurality of interface objects or the second plurality of interface objects selected from the top of the stack.

6. The method set forth in claim 1, wherein accessing the platform identifier occurs in response to beginning execution of the application and providing the graphical interface occurs while the computer application is executing and after the platform identifier has been accessed.

7. A computer program product comprising a non-transitory computer-readable medium embodying program components of an application executable by a computing system, the program components comprising:
an application logic module comprising code for accessing an input value and generating an output value based on the input value;
an experience manager module comprising code for:
selecting an interaction model for the computing system based on determining that the interaction model is compliant with at least one guideline corresponding to a platform identifier indicating a characteristic of the computing system, wherein the at least one guideline specifies at least one requirement for applications executed on computing systems having the characteristic of the computing system;
determining at least one input program component for obtaining the input value via an input device of the computing system and corresponding to an input object identified in the interaction model; and
determining at least one output program component for providing the output value via an output device of the computing system and corresponding to an output object identified in the interaction model; and
a graphical interface module comprising code for generating a graphical interface based on the interaction model by instantiating a plurality of interface objects identified in the interaction model, wherein the plurality of interface objects as instantiated comprises respective instances of the at least one input program component and the at least one output program component.

8. The computer program product set forth in claim 7, wherein selecting the interaction model comprises selecting one interaction model from a plurality of interaction models based on an identity of the computing system specified in the platform identifier.

9. The computer program product set forth in claim 8, wherein the plurality of interface objects comprises at least one of a title bar, a toolbar, or a navigation bar, each interface element generated based on a corresponding interface object.

10. The computer program product set forth in claim 9,
wherein the application logic module further comprises code for defining a plurality of screens, each screen of the plurality of screens including at least one respective interface object of the plurality of interface objects, and
wherein the experience manager module further comprises code for defining a respective visual representation for each screen by determining, based on the interaction model, the at least one respective interface object of the plurality of interface objects for rendering a corresponding at least one of the plurality of interface objects.

11. The computer program product set forth in claim 10, wherein the experience manager module further comprises code for defining, for each screen, the respective visual representation by determining, based on the interaction model, how the interface objects are laid out in the screen.

12. The computer program product set forth in claim 10, wherein the application logic module further comprises code for maintaining a stack defining the plurality of screens, the stack comprising the plurality of interface objects and data associating each of the plurality of interface objects with respective screens.

13. The computer program product set forth in claim 12, wherein the stack further comprises, for at least some of the plurality of screens, a data model defining data used in populating at least some instances of the plurality of interface objects of the graphical interface.

14-19. (canceled)

20. The method of claim 1, wherein the interaction model comprises mark-up language code identifying the plurality of interface objects.

21. The method of claim 1, wherein the characteristic comprises a device type for the computing system.

22. The method of claim 1, further comprising determining that the computing system is restricted to executing applications compliant with the at least one guideline.

23. The method of claim 1, wherein generating the graphical interface comprises:
accessing an interface module comprising code for configuring the computing system to provide the graphical interface;
providing the plurality of interface objects as instantiated to the interface module for configuring the computing system.

24. A method comprising
identifying, by an application executed on a computing system, at least one function of the application performed in response to an input event;
accessing, by the application, a first interaction model specifying a graphical interface element for generating the input event and a second interaction model specifying an event handler for generating the input event in response to input received by an input device;
determining, by the application, whether the computing system includes the input device; and
generating, by the application, program code corresponding to one of the graphical interface element or the event handler based on whether the computing system includes the input device.

25. The method of claim 24, wherein each of the first interaction model and the second interaction model comprises mark-up language code.

26. The method of claim 24, wherein determining whether the computing system includes the input device comprises accessing a platform identifier for the computing system indicative of whether the computing system includes the input device.
